(19) United States
(12) Patent Application Publication
(10) Pub. No.: US 2009/0141769 A1
(43) Pub. Date: Jun. 4, 2009

(54) Temperature maintenance system for a sensor

(76) Inventors: Darryl Dean Baldwin, Lafayette, IN (US); William Christopher Boley, Lafayette, IN (US)

Correspondence Address: CATERPILLAR/FINNEGAN, HENDERSON, L.L.P., 901 New York Avenue, NW, WASHINGTON, DC, 20001-4413, US

(21) Appl. No.: 11/987,513

(22) Filed: Nov. 30, 2007

(51) Int. Cl. G01K 13/02

(52) U.S. Cl. 374/144; 374/E13.006

(57) ABSTRACT

A sensing system is provided having a bypass configured to divert fluid from a main passageway. In addition, the sensing system has a fluid sensor situated within the bypass and configured to sense a concentration of an element contained within the fluid. The sensing system also has a first heater configured to convey thermal energy to the fluid sensor. Furthermore, the sensing system has a first temperature sensor configured to sense a parameter indicative of a temperature of the fluid sensor. The sensing system further has a controller configured to regulate the first heater in response to the sensed parameter indicative of the temperature of the fluid sensor.

### TECHNICAL FIELD

The present disclosure is directed to a temperature maintenance system and, more particularly, to a temperature maintenance system for a sensor.

### BACKGROUND

Engines, including diesel engines, gasoline engines, natural gas engines, and other engines known in the art, typically produce emissions that contain a variety of pollutants. These pollutants may include, for example, particulate matter, nitrogen oxides (NOx) such as NO and NO₂, and sulfur compounds. Due to increased environmental concerns, among other things, exhaust emission standards may have become more stringent. The amount of particulate matter and gaseous pollutants emitted from an engine may be regulated depending on the type, size, and/or class of engine. In order to meet these emissions standards, engine manufacturers have pursued improvements in several different engine technologies, such as fuel injection, engine management, and air induction, to name a few. In addition, engine manufacturers have developed devices for treatment of engine exhaust after it leaves the engine.

The performance of the exhaust treatment devices, as well as the performance of the engine, may be assessed by determining the amount of emissions in the engine exhaust before it is released into the atmosphere. Such levels of emissions may be determined by employing various sensing devices. Sensing devices oftentimes have an optimal temperature at which they perform most accurately. However, this optimal temperature may be different than the temperature of the exhaust exiting the engine.

One such system that attempts to maintain an exhaust gas sensor at its optimal temperature is described in U.S. Pat. No. 6,341,599 (the '599 patent) to Hada et al. The '599 patent discloses an engine system having a main exhaust passageway. A sensor is situated in the main exhaust passageway to sense a concentration of oxygen and carbon monoxide in the exhaust gas. In addition, a heating element is disposed within the sensor to maintain the sensor at an optimal temperature. This optimal temperature is the temperature at which the sensor can provide the most accurate reading of oxygen and carbon monoxide levels.

Although the sensor described in the '599 patent may attempt to maintain the sensor at its optimal temperature, the design may be prone to inaccuracies. In particular, the sensor of the '599 patent heats the sensor to the desired temperature but does not address the temperature of the exhaust that is in contact with the sensor. The temperature of the exhaust contacting the sensor may counteract the effects of the heating element by increasing or decreasing the temperature of the sensor, thereby affecting the accuracy of the sensor.

In addition, the apparatus described in the '599 patent may adversely affect the operation of the engine and exhaust treatment devices. Specifically, the heater element and sensor device are both situated in the exhaust stream. This configuration may obstruct the flow of exhaust and increase back pressure acting against the engine, thereby adversely affecting the engine's performance. Furthermore, because the heating element is situated within the main exhaust passage, it may affect the temperature of the exhaust entering the exhaust treatment devices, which may cause the exhaust treatment devices to perform sub-optimally.

The disclosed system is directed to overcoming one or more of the problems set forth above.

### SUMMARY

In one aspect, the disclosure is directed toward a sensing system. The sensing system includes a bypass configured to divert fluid from a main passageway. In addition, the sensing system includes a fluid sensor situated within the bypass and configured to sense a concentration of an element contained within the fluid. The sensing system also includes a first heater configured to convey thermal energy to the fluid sensor. Furthermore, the sensing system includes a first temperature sensor configured to sense a parameter indicative of a temperature of the fluid sensor. The sensing system further includes a controller configured to regulate the first heater in response to the sensed parameter indicative of the temperature of the fluid sensor.

Consistent with a further aspect of the disclosure, a method is provided for sensing a concentration of an element contained within a fluid. The method includes diverting fluid from a main fluid stream and sensing a first parameter indicative of a temperature of a fluid sensing device. The method also includes sensing a second parameter indicative of a temperature of the diverted fluid. In addition, the method includes adjusting the temperature of the fluid sensing device in response to the sensed first parameter so that the temperature of the fluid sensing device is substantially the same as a desired temperature. Furthermore, the method includes adjusting the temperature of the diverted fluid in response to the sensed second parameter so that the temperature of the diverted fluid is substantially the same as the desired temperature. The method further includes sensing a third parameter indicative of a concentration of an element contained within the diverted fluid when the temperature of the fluid sensing device and the diverted fluid are substantially the same as the desired temperature.

### BRIEF DESCRIPTION OF THE DRAWINGS

FIG. 1 is a diagrammatic illustration of an exemplary disclosed power source and associated exhaust system;

FIG. 2 is a schematic diagram of a sensing system for use with the exhaust system of FIG. 1; and

FIG. 3 is a flow diagram of an exemplary method for maintaining a temperature of an exhaust gas and the exhaust gas sensor of the sensing system of FIG. 2.

### DETAILED DESCRIPTION

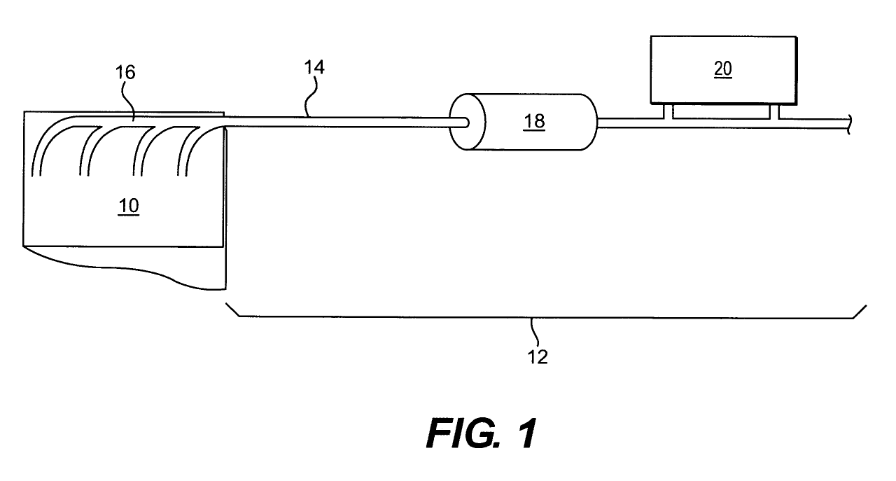

FIG. 1 illustrates an exemplary power source 10 including an internal combustion engine having multiple subsystems that cooperate to produce mechanical or electrical power output. For the purposes of this disclosure, power source 10 is depicted and described as a four-stroke diesel engine. One skilled in the art will recognize, however, that power source 10 may be any other type of internal combustion engine such as, for example, a gasoline or a gaseous fuel-powered engine. One subsystem included within power source 10 may be an exhaust system 12. Other subsystems included within power source 10 may be, for example, a fuel system, an air induction system, a lubrication system, a cooling system, or any other appropriate system (not shown).

Exhaust system 12 may remove or reduce the amount of pollutants in the exhaust produced by power source 10 and release the treated exhaust into the atmosphere. Exhaust system 12 may include an exhaust passage 14, which may be in fluid communication with an exhaust manifold 16 of power source 10. Exhaust system 12 may also include an exhaust treatment device 18 fluidly connected to exhaust passage 14, and a sensor system 20. Exhaust treatment device 18 may be, for example, a catalytic device, a particulate trap, an attenuation device, or any device capable of removing pollutants from exhaust gas flowing through exhaust passage 14. Although exhaust system 12 is illustrated including only one exhaust treatment device 18, it is contemplated that exhaust treatment system 12 may include multiple exhaust treatment devices 18, if desired. It is further contemplated that sensor system 20 may be located upstream or downstream of exhaust treatment device 18. It is yet further contemplated that exhaust treatment system may include multiple sensor systems 20.

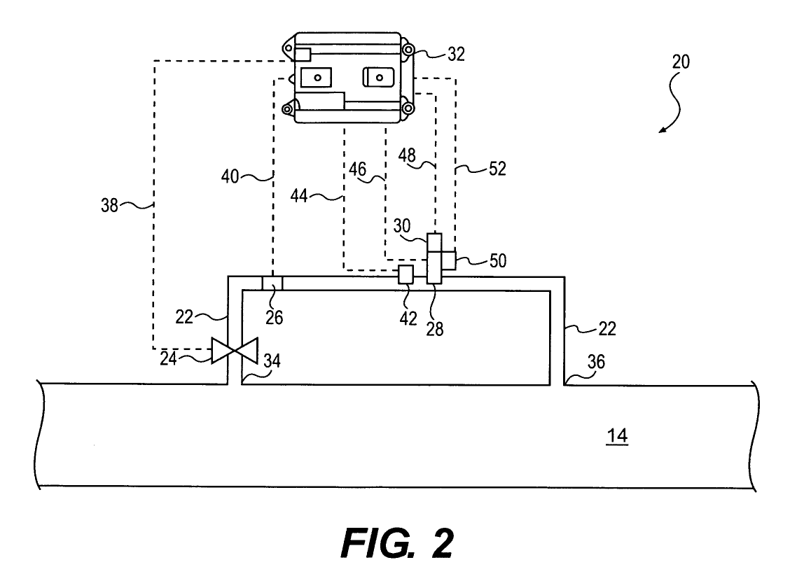

FIG. 2 illustrates an exemplary sensor system 20, which may divert a portion of the exhaust gas flowing through exhaust passage 14 and sense a concentration of an element in the exhaust gas. The element may include, for example, particulate matter, NOx, sulfur compounds, or any other type of emissions that may be found in the exhaust gas. Sensor system 20 may include a bypass 22, a valve 24, an exhaust gas heating element 26 for conveying thermal energy to the exhaust gas flowing through bypass 22, an exhaust gas sensor 28 for sensing the concentration of the element in the exhaust gas, a sensor heating element 30 for conveying thermal energy to exhaust gas sensor 28, and a controller 32 for regulating valve 24, exhaust gas heating element 26, and sensor heating element 30.

Bypass 22 may convey a portion of the exhaust gas from exhaust passage 14 through sensor system 20. In addition, bypass 22 may include an inlet port 34 where exhaust gas may enter sensor system 20 and an outlet port 36 where exhaust gas may exit sensor system 20. In addition, bypass 22 may be made from or lined with an insulating material that may inhibit and/or reduce the transmission of thermal energy into and out of bypass 22. The insulating material may include, for example, heat resistant ceramics, foams, or any other material capable of insulating bypass 22.

Valve 24 may be located within bypass 22 downstream of inlet port 34 and upstream of exhaust gas heating element 26 and may regulate the flow of exhaust through sensor system 20. In addition, valve 24 may be any type of valve such as, for example, a butterfly valve, a diaphragm valve, a gate valve, a ball valve, a globe valve, or any other valve known in the art. Furthermore, valve 24 may communicate with controller 32 via a communication line 38 and may be solenoid-actuated, hydraulically-actuated, pneumatically-actuated or actuated in any other manner to selectively restrict the flow of exhaust gas through bypass passageway 22. It is contemplated that valve 24 may be omitted, if desired.

Exhaust gas heating element 26 may heat exhaust gas flowing through bypass 22 to a desired temperature, which may be substantially the same as a temperature at which exhaust gas sensor 28 may most accurately operate. Exhaust gas heating element 26 may be coupled to an interior surface of bypass 22 downstream from valve 24 and upstream of exhaust gas sensor 28 in such a manner that the exhaust gas may come into direct contact with and flow through exhaust gas heating element 26. Because exhaust gas heating element 26 may be directly exposed to the exhaust gas, exhaust gas heating element 26 may be prone to corrosion due to the corrosive nature of some of the elements contained within the exhaust gas. To prevent such corrosion, it is contemplated that exhaust gas heating element 26 may be coated with an anti-corrosive material that may have high heat transferring properties. In addition, exhaust gas heating element 26 may include a coil winding (not shown) that may generate heat upon receiving a current. Such a current may be supplied to exhaust gas heating element 26 from controller 32 or any other suitable source, causing the temperature of exhaust gas heating element 26 to increase. Furthermore, exhaust gas heating element 26 may be in communication with controller 32 via a communication line 40.

In an alternate embodiment, exhaust gas heating element 26 may substantially surround bypass 22 and may convey thermal energy to the exhaust gas via the walls of bypass 22. In such an embodiment, the conveyance of thermal energy through the walls of bypass 22 may be permitted by omitting the insulating material where bypass 22 contacts exhaust gas heating element 26.

A temperature sensor 42 may be situated within bypass 22 downstream of exhaust gas heating element 26. The exact location of temperature sensor 42 may be chosen so that temperature sensor 42 may sense a parameter indicative of a temperature of the exhaust gas flowing through or adjacent to exhaust gas sensor 28. In addition, temperature sensor 42 may be, for example, a thermocouple, a thermistor, or any other type of temperature sensing device capable of sending a signal indicative of an exhaust gas temperature to controller 32. Furthermore, temperature sensor 42 may communicate with controller 32 via a communication line 44.

Exhaust gas sensor 28 may sense a parameter indicative of the amount of an element contained within the exhaust gas. The element may be, for example, particulate matter, NOx, sulfur compounds, or any other emissions contained within the exhaust gas. In addition, exhaust gas sensor 28 may be mounted on bypass 22 upstream of outlet port 36. At least a portion of exhaust gas sensor 28 may extend through the wall of bypass 22 into the exhaust flow. In order to withstand the high temperatures in bypass 22, exhaust gas sensor 28 may be constructed, for example, out of ceramic type metal oxides or any other suitable material. Exhaust gas sensor 28 may sample the exhaust for the element contained within the exhaust gas and convert that sensed value into a signal indicative of the element level therein. Such a signal may be transmitted along a communication line 46 to controller 32.

Sensor heating element 30 may be coupled to exhaust gas sensor 28 and may heat exhaust gas sensor 28 to a desired temperature, which may be substantially the same as a temperature at which exhaust gas sensor 28 may most accurately operate. Sensor heating element 30 may include a coil winding (not shown) that may generate heat upon receiving a current. Such a current may be supplied to sensor heating element 30 from controller 32 or any other suitable source, causing the temperature of sensor heating element 30 to increase. In addition, sensor heating element 30 may be in communication with controller 32 via a communication line 48.

A temperature sensor 50 may be coupled to exhaust gas sensor 28. Temperature sensor 50 may sense a parameter indicative of a temperature of exhaust gas sensor 28 and may be any temperature sensing device such as, for example, a thermocouple, a thermistor, or any other type of temperature sensing device capable of sending a signal indicative of a temperature to of sensor 50 to controller 32. In addition, temperature sensor 50 may communicate with controller 32 via a communication line 52.

Controller 32 may regulate valve 24, exhaust gas heating element 26, and sensor heating element 30 in response to temperature signals received from temperature sensors 42 and 50. The regulation of valve 24, exhaust gas heating element 26, and sensor heating element 30 may maintain exhaust gas sensor 28 at a temperature that may be substantially the same as a desired temperature. Such a desired temperature may be a temperature at which exhaust gas sensor 28 may most accurately operate. Upon receiving the temperature signals, controller 32 may compare the current temperatures of the exhaust gas and exhaust gas sensor 28 to algorithms, equations, tables, or charts stored in or accessible by controller 32 to determine a course of action for maintaining exhaust gas sensor 28 and the exhaust gas at the desired temperature. Such a course of action may include for example, setting valve 24 to a particular position, increasing or decreasing the heat output of exhaust gas heating element 26, and increasing or decreasing the heat output of sensor heating element 30.

Controller 32 may take any form such as, for example, a computer based system, a microprocessor based system, a microcontroller, or any other suitable control type circuit or system. In addition, controller 32 may include various components for running software applications designed to regulate valve 24, exhaust gas heating element 26, and sensor heating element 30. For example, controller 32 may include a central processing unit (CPU), a random access memory (RAM), input/output (I/O) elements, etc.

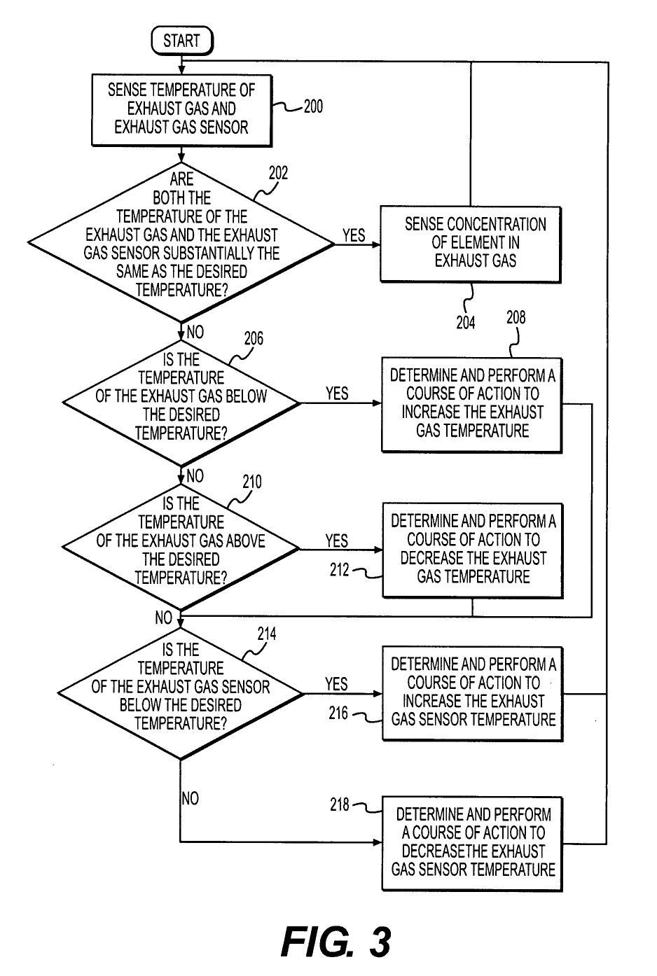

FIG. 3, which is discussed in the following section, illustrates the operation of sensor system 20. In particular, FIG. 3 illustrates an exemplary method for maintaining exhaust gas sensor 28 at a desired temperature.

### INDUSTRIAL APPLICABILITY

The disclosed sensor system may accurately detect an amount of an element contained within an exhaust gas. In particular, the disclosed sensor system may maintain a sensor and the exhaust gas flowing through the sensor at a temperature substantially the same as a desired temperature. This desired temperature may be the temperature at which the sensor may most accurately operate. The operation of sensor system 20 will now be explained.

FIG. 3 illustrates a flow diagram depicting an exemplary method for maintaining exhaust gas sensor 28 at a desired temperature. The method may begin when temperature sensors 42 and 50 may sense a parameter indicative of the temperatures of exhaust gas sensor 28 and the exhaust gas flowing through exhaust gas sensor 28 (step 200). Upon receiving temperature signals from temperature sensors 42 and 50 via communication lines 44 and 52, respectively, controller 32 may determine whether the temperatures of both exhaust gas sensor 28 and the exhaust gas flowing through exhaust gas sensor 28 are substantially the same as a desired temperature (step 202). This desired temperature may be the temperature at which exhaust gas sensor 28 may most accurately detect the amount of an element in the exhaust gas. For example, if exhaust gas sensor 28 is configured to sense an amount of NOx in the exhaust gas, exhaust gas sensor 28 may most accurately detect the amount of NOx when the temperature of exhaust gas sensor 28 is approximately 800 degrees Celsius.

If controller 32 determines that the temperature of both exhaust gas sensor 28 and the exhaust gas flowing through exhaust gas sensor 28 are substantially the same as the desired temperature (step 202: Yes), exhaust gas sensor 28 may sense a parameter indicative of an amount of the element contained within the exhaust gas (step 204). Upon sensing such a parameter, exhaust gas sensor 28 may transmit a signal to whatever device requires the data. In addition, step 200 may be repeated (i.e., temperature sensors 42 and 50 may sense a parameter indicative of the temperatures of exhaust gas sensor 28 and the exhaust gas flowing through exhaust gas sensor 28).

If controller 32 determines that either the temperature of exhaust gas sensor 28 or the exhaust gas flowing through exhaust gas sensor 28 is not substantially the same as the desired temperature (step 202: No), controller 32 may determine whether the temperature of the exhaust gas flowing through exhaust gas sensor 28 is below the desired temperature (step 206). If controller 32 determines that the temperature of the exhaust gas is below the desired temperature (step 206: Yes), controller 32 may reference various algorithms, equations, tables, or charts stored in or accessible by controller 32 to determine and perform a course of action to increase the temperature of the exhaust gas (step 208). For example, controller 32 may increase the heat being generated by exhaust gas heating element 26, actuate valve 24 to reduce the flow of exhaust gas through bypass 22, or any combination thereof. Upon determining and performing a course of action, step 200 may be repeated (i.e., temperature sensors 42 and 50 may sense a parameter indicative of the temperatures of exhaust gas sensor 28 and the exhaust gas flowing through exhaust gas sensor 28).

If controller determines that the temperature of the exhaust gas is not below the desired temperature (step 206: No), controller 32 may determine whether the temperature of the exhaust gas flowing through exhaust gas sensor 28 is above the desired temperature (step 210). If controller 32 determines that the temperature of the exhaust gas is above the desired temperature (step 210: Yes), controller 32 may reference various algorithms, equations, tables, or charts stored in or accessible by controller 32 to determine and perform a course of action to decrease the temperature of the exhaust gas (step 212). For example, controller 32 may decrease the heat being generated by exhaust gas heating element 26, actuate valve 24 to increase the flow of exhaust gas through bypass 22, or any combination thereof. Upon determining and performing a course of action, step 200 may be repeated (i.e., temperature sensors 42 and 50 may sense a parameter indicative of the temperatures of exhaust gas sensor 28 and the exhaust gas flowing through exhaust gas sensor 28).

If controller determines that the temperature of the exhaust gas is not above the desired temperature (step 210: No), controller 32 may determine whether the temperature of exhaust gas sensor 28 is below the desired temperature (step 214). If controller 32 determines that the temperature of exhaust gas sensor 28 is below the desired temperature (step 214: Yes), controller 32 may reference various algorithms, equations, tables, or charts stored in or accessible by controller 32 to determine and perform a course of action to increase the temperature of exhaust gas sensor 28 (step 216). For example, controller 32 may increase the heat being generated by sensor heating element 30, actuate valve 24 to decrease the flow of exhaust gas through bypass 22, or any combination thereof. Upon determining and performing a course of action, step 200 may be repeated (i.e., temperature sensors 42 and 50 may sense a parameter indicative of the temperatures of exhaust gas sensor 28 and the exhaust gas flowing through exhaust gas sensor 28).

If controller determines that the temperature of exhaust gas sensor 28 is above the desired temperature (step 214: No), controller 32 may reference various algorithms, equations, tables, or charts stored in or accessible by controller 32 to determine and perform a course of action to decrease the temperature of exhaust gas sensor 28 (step 218). For example, controller 32 may decrease the heat being generated by sensor heating element 30, actuate valve 24 to increase the flow of exhaust gas through bypass 22, or any combination thereof. Upon determining and performing a course of action, step 200 may be repeated (i.e., temperature sensors 42 and 50 may sense a parameter indicative of the temperatures of exhaust gas sensor 28 and the exhaust gas flowing through exhaust gas sensor 28).

The disclosed sensor system may improve the accuracy emissions level readings performed by the sensor. In particular, maintaining the temperature of the exhaust gas at the desired temperature as it flows through the exhaust gas sensor may prevent the exhaust gas from adversely affecting the temperature of the sensor. Therefore, it may be more likely that the sensor is maintained at its desired temperature, improving the accuracy of the sensor system.

In addition, sensing the amount of undesired emissions in the exhaust gas from a small sampling of the exhaust gas, may reduce any adverse effects of the sensor system on the operation of the engine and/or exhaust treatment devices. In particular, because the heater elements and sensor device are both situated outside the main exhaust stream, their effect on the flow of exhaust in the main stream may be minimal. This may reduce the amount of backpressure generated in the exhaust stream, thereby improving engine performance. In addition, heating only a fraction of the exhaust gas flowing through the exhaust treatment devices may minimally affect the overall temperature of the exhaust gas flowing through the exhaust treatment devices. This may minimize any adverse effects the sensing system may have on the performance of any exhaust treatment devices.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A sensing system, comprising:
a bypass configured to divert fluid from a main passageway;
a fluid sensor situated within the bypass and configured to sense a concentration of an element contained within the fluid;
a first heater configured to convey thermal energy to the fluid sensor;
a first temperature sensor configured to sense a parameter indicative of a temperature of the fluid sensor; and
a controller configured to regulate the first heater in response to the sensed parameter indicative of the temperature of the fluid sensor.

2. The sensing system of claim 1, wherein the bypass includes an insulating material, the insulating material being configured to reduce the amount of heat transfer between the fluid flowing within the bypass and the fluid flowing within the main passageway.

3. The sensing system of claim 2, further including a second heating element configured to convey thermal energy to the fluid flowing through the bypass.

4. The sensing system of claim 3, further including a second temperature sensor configured to sense a parameter indicative of a temperature of the fluid flowing through the bypass.

5. The sensing system of claim 4, wherein the controller is configured to regulate the second heater in response to the sensed parameter indicative of the temperature of the fluid flowing through the bypass.

6. The sensing system of claim 5, wherein the controller is configured to regulate the first and second heaters so that the temperature of the fluid sensor and the temperature of the fluid flowing through the bypass are substantially the same as a desired temperature.

7. The sensing system of claim 6, wherein the desired temperature is the temperature at which the fluid sensor most accurately senses the concentration of the element contained within the fluid.

8. The sensing system of claim 7, further including a valve situated within the bypass and configured to regulate the flow rate of the fluid through the bypass.

9. The sensing system of claim 8, wherein the controller is configured to regulate the valve in response to the sensed parameter indicative of the temperature of the fluid sensor.

10. The sensing system of claim 9, wherein the controller is configured to regulate the valve so that the temperature of the fluid sensor is substantially the same as the desired temperature.

11. A method for sensing a concentration of an element contained within a fluid, comprising:
diverting fluid from a main fluid stream;
sensing a first parameter indicative of a temperature of a fluid sensing device;
sensing a second parameter indicative of a temperature of the diverted fluid;
adjusting the temperature of the fluid sensing device in response to the sensed first parameter so that the temperature of the fluid sensing device is substantially the same as a desired temperature;
adjusting the temperature of the diverted fluid in response to the sensed second parameter so that the temperature of the diverted fluid is substantially the same as the desired temperature; and
sensing a third parameter indicative of a concentration of an element contained within the diverted fluid when the temperature of the fluid sensing device and the diverted fluid are substantially the same as the desired temperature.

12. The method of claim 11, further including regulating the flow rate of the diverted fluid in response to the sensed first parameter so that the temperature of the fluid sensing device is substantially the same as the desired temperature.

13. The method of claim 12, further including regulating the flow rate of the diverted fluid in response to the sensed second parameter so that the temperature of the diverted fluid is substantially the same as the desired temperature.

14. An exhaust system, comprising:
a main exhaust passage;
at least one exhaust treatment device fluidly connected to the exhaust passage; and
a sensing system, including:
a bypass configured to divert exhaust gas from a main passageway;
an exhaust gas sensor situated within the bypass and configured to sense a concentration of an element contained within the exhaust gas;
a first heater configured to convey thermal energy to the fluid sensor;
a second heating element configured to convey thermal energy to the exhaust gas flowing through the bypass;
a first temperature sensor configured to sense a parameter indicative of a temperature of the exhaust gas sensor;
a second temperature sensor configured to sense a parameter indicative of a temperature of the exhaust gas flowing through the bypass; and
a controller configured to regulate the first heater in response to the sensed parameter indicative of the temperature of the exhaust gas sensor and regulate the second heater to in response to the sensed parameter indicative of the temperature of the exhaust gas flowing through the bypass.

15. The exhaust system of claim 14, wherein the bypass includes an insulating material, the insulating material being configured to reduce the amount of heat transfer between the exhaust gas flowing within the bypass and the exhaust gas flowing within the main passageway.

16. The exhaust system of claim 15, wherein the controller is configured to regulate the first and second heaters so that the temperature of the exhaust gas sensor and the temperature of the exhaust gas flowing through the bypass are substantially the same as a desired temperature.

17. The exhaust system of claim 16, wherein the desired temperature is the temperature at which the exhaust gas sensor most accurately senses the concentration of the element contained within the exhaust gas.

18. The exhaust system of claim 17, further including a valve situated within the bypass and configured to regulate the flow rate of exhaust gas through the bypass.

19. The exhaust system of claim 18, wherein the controller is configured to regulate the valve in response to the sensed parameter indicative of the temperature of the exhaust gas sensor.

20. The exhaust system of claim 19, wherein the controller is configured to regulate the valve so that the temperature of the exhaust gas sensor is substantially the same as the desired temperature.
